(19) United States
(12) Patent Application Publication
(10) Pub. No.: US 2025/0279482 A1
(43) Pub. Date: Sep. 4, 2025

(54) SOLID-STATE SECONDARY BATTERY AND METHOD OF MANUFACTURING THE SAME

(71) Applicant: HONDA MOTOR CO., LTD., Tokyo (JP)

(72) Inventors: Kizashi IWAKIRI, Saitama (JP); Takuya TANIUCHI, Saitama (JP); Toshimitsu TANAKA, Saitama (JP); Keisuke TSUTA, Saitama (JP); Tomohiko TSUZAKI, Saitama (JP)

(21) Appl. No.: 19/056,768

(22) Filed: Feb. 19, 2025

(30) Foreign Application Priority Data
Mar. 1, 2024 (JP) 2024-031604

(51) Int. Cl. H01M 10/0585; H01M 10/0525

(52) U.S. Cl. CPC H01M 10/0585; H01M 10/0525

(57) ABSTRACT

A solid-state secondary battery according one embodiment of the present invention includes an electrode laminate that includes a positive electrode layer, a negative electrode layer, and a solid electrolyte layer laminated between the positive electrode layer and the negative electrode layer, and an insulating frame placed on side surfaces of the positive electrode layer with a gap between the positive electrode layer and the insulating frame, in which at least a portion of the insulating frame is pressed in a laminating direction of the electrode laminate and is spread toward a side of the positive electrode layer.

This application is based on and claims the benefit of priority from Japanese Patent Application No. 2024-031604, filed on 1 Mar. 2024, the content of which is incorporated herein by reference.

### BACKGROUND OF THE INVENTION

### Field of the Invention

The present invention relates to a solid-state secondary battery and a method of manufacturing the same.

### Related Art

In recent years, research and development have been conducted on battery modules that contribute to energy efficiency, in order to enable more people to access affordable, reliable, sustainable, and advanced energy. Among secondary batteries, solid-state secondary batteries including an electrode laminate in which a solid electrolyte layer is placed between a positive electrode layer and a negative electrode layer have particularly attracted attention since they are excellent in terms of improved safety thanks to non-flammable solid electrolytes and have higher energy density. In a solid-state secondary battery, an insulator is placed around the positive electrode layer to prevent a positional deviation between the positive layer, the solid electrolyte layer, and the negative electrode layer in the electrode laminate and a short circuit in the electrode laminate, thereby insulating side surfaces of the positive electrode layer. Studies are underway to use, as the insulator, a multi-layer structure including a first resin layer and a second resin layer in this order from a side closer to side surfaces of the electrode laminate and an elastic modulus of the first resin layer is lower than an elastic modulus of the second resin layer (Patent Document 1).

Patent Document 1: Japanese Unexamined Patent Application, Publication No. 2019-153535

### SUMMARY OF THE INVENTION

Incidentally, in the solid-state secondary battery, a challenge is to extend a lifetime thereof. It is effective to place an insulator around the positive electrode layer in the solid-state secondary battery in order to extend the lifetime of the solid-state secondary battery. The use of an insulating frame with a high shape stability as the insulator is effective in extending the lifetime of the solid-state secondary battery. However, it is difficult to place the insulating frame with a high shape stability without a gap between side surfaces of the positive electrode layer and the insulating frame. If a gap exists between the side surfaces of the positive electrode layer and the insulating frame, the position of the positive electrode layer is easily moved when the solid-state secondary battery vibrates, which causes a positional deviation between the positive electrode layer and the negative electrode layer facing each other and a variation in surface pressure of the positive electrode layer, and the like.

The present invention has been made in view of the above-described circumstances, and an object thereof is to provide a solid-state secondary battery with a small gap between a positive electrode layer and an insulating frame, and a method of manufacturing the same. Consequently, the solid-state secondary battery contributes to energy efficiency.

The present inventors have found that the above-described problems can be solved by placing, on side surfaces of a positive electrode layer, an easily deformable insulating frame that can be deformed by being pressed, with a gap between the insulating frame and the side surfaces of the positive electrode layer, and spreading the insulating frame to fill at least a portion of the gap, thereby completing the present invention. Thus, the present invention provides the following aspects.

(1) A solid-state secondary battery including an electrode laminate that includes a positive electrode layer, a negative electrode layer, and a solid electrolyte layer laminated between the positive electrode layer and the negative electrode layer, and an insulating frame placed on side surfaces of the positive electrode layer with a gap between the positive electrode layer and the insulating frame, in which at least a portion of the insulating frame is pressed in a laminating direction of the electrode laminate and is spread toward a side of the positive electrode layer.

According to the solid-state secondary battery of (1), at least a portion of the insulating frame is spread toward the positive electrode layer side by being pressed in the laminating direction of the electrode laminate, and thus a gap between the positive electrode layer and the insulating frame can be reduced.

(2) The solid-state secondary battery described in (1), in which the insulating frame includes a body with a low Young's modulus and a body with a high Young's modulus placed on an outer periphery of the body with a low Young's modulus, the body with a low Young's modulus is spreadable and deformable in a direction perpendicular to a pressing direction by being pressed, the body with a high Young's modulus has a Young's modulus higher than a Young's modulus of the body with a low Young's modulus, and at least a portion of the body with a low Young's modulus of the insulating frame is spread and deformed toward the side of the positive electrode layer by being pressed in the laminating direction of the electrode laminate.

According to the solid-state secondary battery of (2), the body with a high Young's modulus is placed on the outer periphery of the body with a low Young's modulus, and thus the body with a low Young's modulus becomes difficult to be spread and deformed toward an outer peripheral side, and becomes easy to be spread and deformed toward the side of the positive electrode layer. Therefore, such spread and deformation of the body with a low Young's modulus makes it possible to reduce the gap between the positive electrode layer and the insulating frame.

(3) The solid-state secondary battery described in (1), in which the insulating frame includes a composite that includes a porous body, and a gelatinous insulating material immersed in the porous body, the composite can extrude the gelatinous insulating material in a direction perpendicular to a pressing direction by being pressed, and at least a portion of the composite of the insulating frame is pressed in the laminating direction of the electrode laminate, so that the gelatinous insulating material is extruded toward the side of the positive electrode layer.

According to the solid-state secondary battery of (3), the gelatinous insulating material is extruded from the composite, resulting in spread of the insulating frame, and thus a gap between the positive electrode layer and the insulating frame can be reduced.

(4) The solid-state secondary battery described in (3), in which the insulating frame further includes a non-porous member that covers an outer peripheral surface of the composite on an opposite side of the side of the positive electrode layer.

According to the solid-state secondary battery of (4), the gelatinous insulating material can be efficiently extruded between the positive electrode layer and the insulating frame when the composite is pressed, and thus a gap between the positive electrode layer and the insulating frame can be reduced more reliably.

(5) The solid-state secondary battery described in any one of (1) to (4), in which at least one of the solid electrolyte layer and the negative electrode layer has a projection projecting from an edge of the positive electrode layer in a plan view, and at least a portion of the insulating frame is pressed via the projection.

According to the solid-state secondary battery of (5), the insulating frame is pressed via the projection of the electrode laminate, and thus the insulating frame can be pressed stably for a long period of time.

(6) The solid-state secondary battery described in any one of (1) to (5), in which the positive electrode layer includes a positive electrode current collector, and a positive electrode active material layer laminated on one surface or both surfaces of the positive electrode current collector, and the negative electrode layer and the solid electrolyte layer are placed on opposite sides of the positive electrode layer to face each other.

According to the solid-state secondary battery of (6), the insulating frame is pressed by the negative electrode layers placed on opposite sides of the positive electrode active material layer to face each other and/or the negative electrode layer in the electrode laminate, and thus the insulating frame can be pressed stably for a long period of time.

(7) A method of manufacturing a solid-state secondary battery including an electrode laminate that includes a positive electrode layer, a negative electrode layer, and a solid electrolyte layer laminated between the positive electrode layer and the negative electrode layer, and an insulating frame placed on side surfaces of the positive electrode layer, the method including placing the solid electrolyte layer between the positive electrode layer and the negative electrode layer, pressing the insulating frame in a state of being placed on side surfaces of the positive electrode layer with a gap between the insulating frame and the positive electrode layer to obtain the electrode laminate, and pressing and spreading at least a portion of the insulating frame so that at least a portion of the gap is filled.

According to the method of manufacturing the solid-state secondary battery of (7), the electrode laminate is obtained and at least a portion of the insulating frame is pressed to fill a gap between the side surfaces of the positive electrode layer and the insulating frame, and thus it is not particularly required to strictly match the size of the insulating frame with the size of the positive electrode layer. This makes it possible to industrially advantageously manufacture the solid-state secondary battery with a small gap between the side surfaces of the positive electrode layer and the insulating frame.

The present invention makes it possible to provide a solid-state secondary battery with a small gap between a positive electrode layer and an insulating frame, and a method of manufacturing the same.

### BRIEF DESCRIPTION OF THE DRAWINGS

FIG. 1 is a plan view illustrating a solid-state secondary battery according to a first embodiment of the present invention;

FIG. 2 is a sectional view taken along line II-II of FIG. 1;

FIG. 3 is a sectional view taken along line III-III of FIG. 1;

FIG. 4 is a sectional view of the solid-state secondary battery illustrated in FIG. 1 in a charged state;

FIG. 5 is a sectional view illustrating one process of a method of manufacturing the solid-state secondary battery according to the first embodiment of the present invention;

FIG. 6 is a sectional view illustrating a modified example of the solid-state secondary battery according to the first embodiment of the present invention;

FIG. 7 is a sectional view illustrating the solid-state secondary battery of the modified example illustrated in FIG. 6 in a charged state;

FIG. 8 is a plan view illustrating a solid-state secondary battery according to a second embodiment of the present invention;

FIG. 9 is a sectional view illustrating the solid-state secondary battery illustrated in FIG. 8 in a charged state;

FIG. 10A is a sectional view illustrating one process of a method of manufacturing the solid-state secondary battery according to the second embodiment of the present invention;

FIG. 10B is a sectional view illustrating another process of a method of manufacturing the solid-state secondary battery according to the second embodiment of the present invention;

FIG. 11 is a sectional view illustrating a modified example of the solid-state secondary battery according to the second embodiment of the present invention; and

FIG. 12 is a sectional view illustrating one process of a method of manufacturing the solid-state secondary battery of the modified example illustrated in FIG. 11.

### DETAILED DESCRIPTION OF THE INVENTION

Embodiments of the present invention will be described below with reference to the drawings. It should be noted, however, that the embodiments below are illustrative of the present invention, and the present invention is not limited to the following description.

### First Embodiment

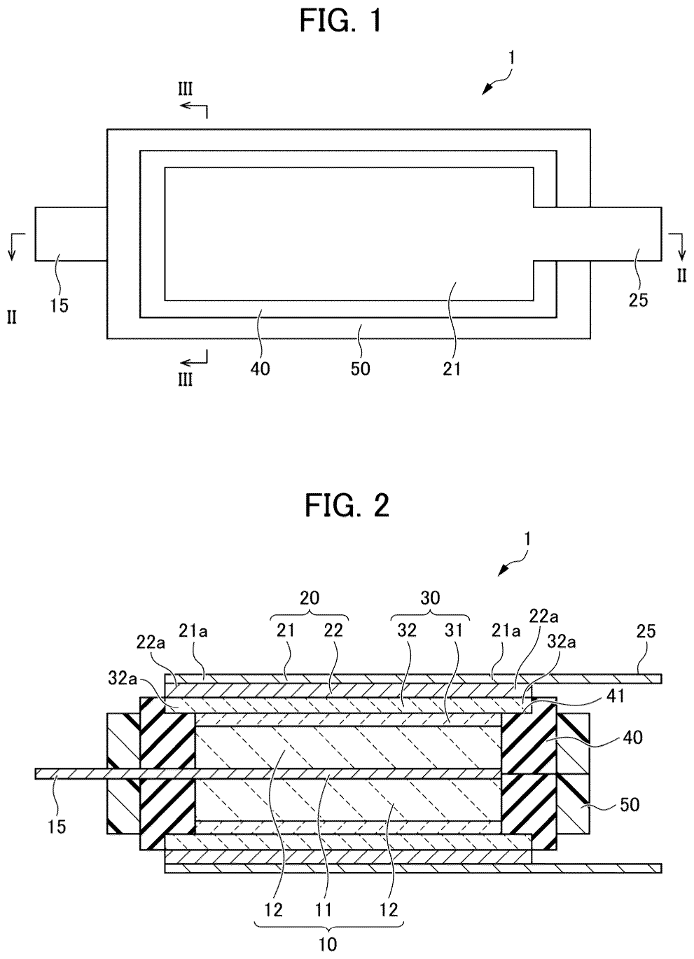

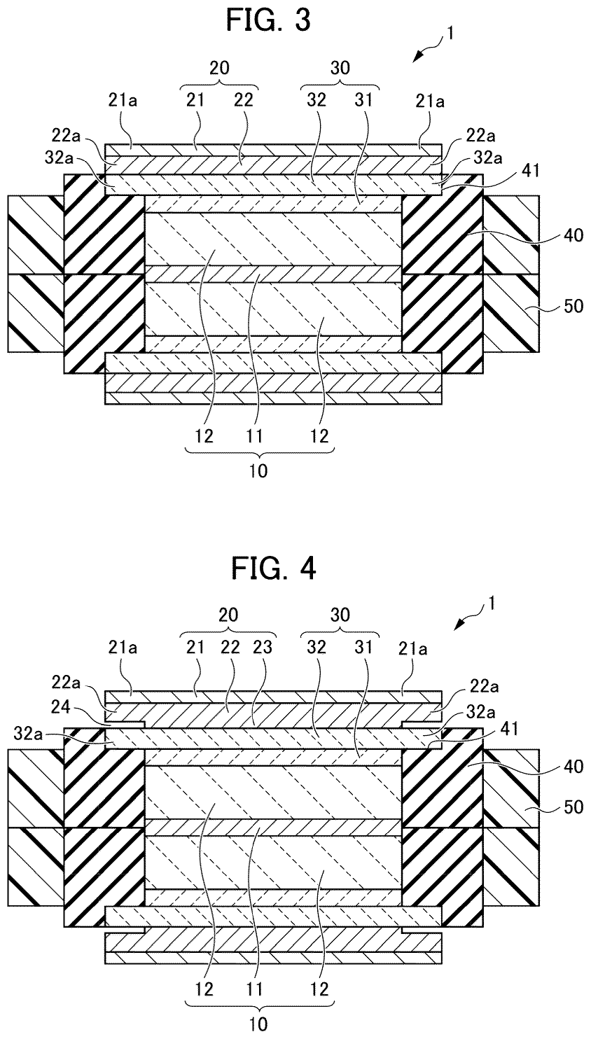

FIG. 1 is a plan view illustrating an electrode laminate used in a solid-state secondary battery according to a first embodiment of the present invention. FIG. 2 is a sectional view taken along line II-II of FIG. 1, and FIG. 3 is a sectional view taken along line III-III of FIG. 1.

As illustrated in FIGS. 1 to 3, the solid-state secondary battery includes an electrode laminate 1, a body 40 with a low Young's modulus, and a body 50 with a high Young's modulus.

The electrode laminate 1 is a laminate including a positive electrode layer 10, a negative electrode layer 20, and a solid electrolyte layer 30 placed between the positive electrode layer 10 and the negative electrode layer 20. The positive electrode layer 10 includes a positive electrode current collector 11, and two positive electrode active material layers 12 laminated on respective surfaces of the positive electrode current collector 11. The negative electrode layer 20 and the solid electrolyte layer 30 are placed on opposite sides of the positive electrode layer 10 to face each other. Each of two negative electrode layers 20 facing each other includes a negative electrode current collector 21, and a metal layer 22 laminated on a surface on the solid electrolyte layer 30 side of the negative electrode current collector 21. The solid electrolyte layer 30 includes a first solid electrolyte layer 31 placed on the positive electrode layer 10 side, and a second solid electrolyte layer 32 placed on the negative electrode layer 20 side. The first solid electrolyte layer 31 has the same dimensions as the positive electrode layer 10 in a plan view. The second solid electrolyte layer 32 has a second solid electrolyte layer projection 32a projecting from an edge of the positive electrode layer 10 in a plan view. The second solid electrolyte layer projections 32a are placed on opposite sides of the positive electrode layer 10 to face each other. The negative electrode current collector 21 and the metal layer 22 have the same dimensions as the second solid electrolyte layer 32 in a plan view, and have a negative electrode current collector projection 21a and a metal layer projection 22a, respectively.

The body 40 with a low Young's modulus is placed on side surfaces of the positive electrode layer 10. The body 40 with a low Young's modulus is a member that is spreadable and deformable in a direction perpendicular to a pressing direction by being pressed. An end surface of the body 40 with a low Young's modulus in a thickness direction contacts the second solid electrolyte layer projection 32a. An outer periphery of the body 40 with a low Young's modulus is located beyond the second solid electrolyte layer projection 32a. The body 40 with a low Young's modulus is pressed by the second solid electrolyte layer projection 32a in a laminating direction of the electrode laminate 1, so that a deformed portion 41 is formed, and the body 40 with a low Young's modulus is spread and deformed toward a side of the positive electrode active material layer 12 of the positive electrode layer 10. When being spread and deformed, the body 40 with a low Young's modulus fills a gap between the side surfaces of the positive electrode layer 10 and the body 40 with a low Young's modulus. When the body 40 with a low Young's modulus is spread and deformed until contacting the positive electrode layer 10, the gap between the positive electrode layer 10 and the body 40 with a low Young's modulus disappears. The body 40 with a low Young's modulus need not to entirely contact the positive electrode active material layers 12, and may contact a portion of the positive electrode layer 10. When the deformed portion 41 is formed, the adhesion between the body 40 with a low Young's modulus and the second solid electrolyte layer projections 32a is enhanced, thereby making it difficult for foreign objects to enter between the positive electrode layer 10 and the body 40 with a low Young's modulus. A Young's modulus of the body 40 with a low Young's modulus may fall, for example, within a range of 5×10⁻⁴ GPa or more and 20 GPa or less.

The body 40 with a low Young's modulus has electron insulating properties. The melting point of the body 40 with a low Young's modulus may be a temperature equal to or higher than the melting point of the lithium. The body 40 with a low Young's modulus preferably has chemical resistance. The Poisson's ratio of the body 40 with a low Young's modulus may fall, for example, within a range of 0.2 or more and 0.49 or less. The body 40 with a low Young's modulus may be an elastic body. As the material of the body 40 with a low Young's modulus, a resin can be used. The resin includes rubber and elastomer. Examples of the resin include PET, PTFE, PI, PVdF, and SBR. The resin may be used alone or two or more thereof may be used in combination.

The body 50 with a high Young's modulus is placed on an outer periphery (surfaces opposite to the positive electrode layer 10 side) of the body 40 with a low Young's modulus. The body 50 with a high Young's modulus may be either bonded or unbonded to the body 40 with a low Young's modulus. The body with a high Young's modulus has a Young's modulus higher than that of the body 40 with a low Young's modulus, and is more difficult to be deformed than the body 40 with a low Young's modulus. Therefore, the body 40 with a low Young's modulus becomes difficult to be spread and deformed toward a side of the body 50 with a high Young's modulus, and becomes easy to be spread and deformed toward a side of the positive electrode layer 10. Therefore, placing the body 50 with a high Young's modulus makes it possible to ensure greater adhesion between the body 40 with a low Young's modulus and the positive electrode layer 10. A Young's modulus of the body 50 with a high Young's modulus may fall, for example, within a range of 5×10⁻³ GPa or more and 200 GPa or less. A ratio of the Young's modulus of the body 50 with a high Young's modulus to the Young's modulus of the body 40 with a low Young's modulus may fall, for example, within a range of 10 times or more and 10⁶ times or less.

The body 50 with a high Young's modulus has electron insulating properties. The melting point of the body 50 with a high Young's modulus may be a temperature equal to or higher than the melting point of the lithium. The body 50 with a high Young's modulus preferably has chemical resistance. The body 50 with a high Young's modulus may have any material as long as it has a Young's modulus higher than that the body 40 with a low Young's modulus. As the material of the body 50 with a high Young's modulus, for example, resin, a ceramic material, or a mixture of resin and a ceramic material can be used. The resin includes rubber and elastomer. Examples of the resin include PET, PTFE, PI, PVdF, and SBR. The resin and the ceramic material may be used alone or two or more thereof may be used in combination.

The electrode laminate 1 is housed in an exterior housing body (not illustrated). The exterior housing body includes a positive electrode terminal to be connected to a positive electrode current collecting tab 15, and a negative electrode terminal to be connected to a negative electrode current collecting tab 25.

The positive electrode current collector 11 may have any material and shape as long as it has the function of collecting current from the positive electrode layer 10. Examples of the material of the positive electrode current collector 11 include aluminum, an aluminum alloy, stainless steel, nickel, iron, and titanium, and among them, aluminum, an aluminum alloy, and stainless steel are preferable. Examples of the shape of the positive electrode current collector 11 include a foil shape, and a plate shape.

The positive electrode active material layer 12 contains at least one type of positive electrode active material. The positive electrode active material is not limited to particular one, and a positive electrode active material which is used in the positive electrode layer in a general solid-state secondary battery can be used. Examples of the positive electrode active material which can be used include a lithium-containing layered active material, a spinel-type active material, and an olivine-type active material. Specific examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganate (LiMn₂O₄), a different element substituted Li—Mn spinel represented by Li₁₊ₓMn_{2-x-y}Mo₄ (x+Y=2, M=at least one selected from Al, Mg, Co, Fe, Ni, and Zn), lithium titanate (oxide including Li and Ti), and lithium metal phosphate (LiMPO₄, M=at least one selected from Fe, Mn, Co and Ni).

In terms of enhancing the conductivity for lithium ions, the positive electrode active material layer 12 may optionally include a solid electrolyte. The positive electrode active material layer 12 may optionally include a conductive aid to enhance the conductivity. Furthermore, in terms of developing the flexibility, the positive electrode active material layer 12 may optionally include a binder. The solid electrolyte, the conductive aid, and the binder are not limited to particular ones, and a solid electrolyte, a conductive aid, and a binder which are used in the positive electrode layer in a general solid-state secondary battery can be used.

The positive electrode current collecting tab 15 may be made of the same material as the positive electrode current collector 11, or may be made of a material different from the positive electrode current collector 11. The positive electrode current collecting tab 15 may be integrally connected to the positive electrode current collector 11. In the present embodiment, the positive electrode current collecting tab 15 is formed as an extension of the positive electrode current collector 11, and is integrally connected to the positive electrode current collector 11.

The negative electrode current collector 21 may have any material and shape as long as it has the function of collecting current from the negative electrode layer 20. Examples of the material of the negative electrode current collector 21 include nickel, copper, and stainless steel. Examples of the shape of the negative electrode current collector 21 include a foil shape, and a plate shape.

The metal layer 22 may have any material and shape as long as it has the function of densely depositing lithium ions. As the metal layer 22, metallic lithium layer or a layer of metal which generates an alloy with lithium can be used. Examples of the metal which forms an alloy with lithium include Mg, Si, Au, Ag, In, Ge, Sn, Pb, Al, and Zn. The metal which forms the metal layer 22 may be in the shape of powder or may be in the shape of a thin film. The negative electrode layer 20 which includes this metal layer 22 is used, so that the lithium deposited layer can be uniformly generated on the surface of the metal layer 22.

The negative electrode current collecting tab 25 may be made of the same material as the negative electrode current collector 21, or may be made of a material different from the negative electrode current collector 21. The negative electrode current collecting tab 25 may be integrally connected to the negative electrode current collector 21. In the present embodiment, the negative electrode current collecting tab 25 is formed as an extension of the negative electrode current collector 21, and is integrally connected to the negative electrode current collector 21.

The thickness of the first solid electrolyte layer 31 of the solid electrolyte layer 30 may be either the same as or different from the thickness of the second solid electrolyte layer 32. The thickness of the second solid electrolyte layer 32 may be, for example, thicker than the thickness of the first solid electrolyte layer 31. The thickness of the second solid electrolyte layer 32 may fall, for example, within a range of 1 time or more and 100 times or less with respect to the thickness of the first solid electrolyte layer 31.

The solid electrolyte layer 30 contains at least one type of solid electrolyte. The solid electrolyte layer 30 can conduct the lithium ions between the positive electrode layer 10 and the negative electrode layer 20 via the solid electrolyte. The first solid electrolyte layer 31 and the second solid electrolyte layer 32 may contain either the same solid electrolyte or a different solid electrolyte.

Although the solid electrolyte is not limited to particular one as long as it has the conductivity for lithium ions, examples of the solid electrolyte which can be used include a sulfide solid electrolyte, an oxide solid electrolyte, a nitride solid electrolyte, and a halide solid electrolyte.

Examples of the sulfide solid electrolyte include Li₂S—P₂S₅, and Li₂S—P₂S₅—LiI. The sulfide solid electrolyte may have an argyrodite type crystal structure.

Examples of the oxide solid electrolyte include a NASICON type oxide, a garnet type oxide, and a perovskite type oxide. Examples of the NASICON type oxide include oxides containing Li, Al, Ti, P, and O (for example, Li_{1.5}Al_{0.5}Ti_{1.5} (PO₄)₃). Examples of the garnet type oxide include oxides containing Li, La, Zr, and O (for example, Li₇La₃Zr₂O₁₂). Examples of the perovskite type oxide include oxides containing Li, La, Ti, and O (for example, LiLaTiO₃).

The solid electrolyte layer 30 may include a binder. The binder is not limited to particular one, and a binder which is used in the solid electrolyte layer in a general solid-state secondary battery can be used.

The solid electrolyte layer 30 may have an inner porous substrate. As the porous substrate, for example, a woven or nonwoven fabric can be used. The solid electrolyte having an inner porous substrate has high strength.

The exterior housing body can be expanded and contracted as the thickness of the negative electrode layer 20 is changed due to charge and discharge. As the material of the exterior housing body, a laminate film can be used. As the laminate film, a laminate film having a three-layer structure can be used in which an inner resin layer, a metal layer, and an outer resin layer are laminated in this order from the inside. The outer resin layer may be, for example, a polyamide (nylon) layer, or a polyethylene terephthalate (PET) layer, the metal layer may be, for example, an aluminum layer, and the inner resin layer may be, for example, a polyethylene layer, or a polypropylene layer.

The electrode laminate 1 illustrated in FIGS. 1 to 3 is a discharged state. When the electrode laminate 1 is charged, lithium ions serving as charge transfer media released from the positive electrode active material layer 12 pass through the solid electrolyte layer 30, and are deposited on the surface of the metal layer 22 of the negative electrode layer 20 to generate a lithium deposited layer, resulting in an increase in thickness of the negative electrode layer 20. The lithium deposited layer serves as the negative electrode active material layer, and releases lithium ions during discharging. Therefore, in the electrode laminate 1, the thickness of the negative electrode layer 20 changes due to charge and discharge.

FIG. 4 is a sectional view of an electrode laminate of the solid-state secondary battery according to the first embodiment of the present invention in a charged state. As illustrated in FIG. 4, in an electrode laminate 1 in a charged state, a lithium deposited layer 23 is generated on a surface of the metal layer 22 of the negative electrode layer 20, resulting in an increase in thickness of the negative electrode layer 20 in a portion facing the positive electrode layer 10. This may cause a slight gap 24 to be formed between the metal layer projection 22a and the second solid electrolyte layer projection 32a, but if a constant pressure is applied to the body 40 with a low Young's modulus from the second solid electrolyte layer projection 32a, it becomes difficult to generate a gap between the body 40 with a low Young's modulus and the positive electrode layer 10.

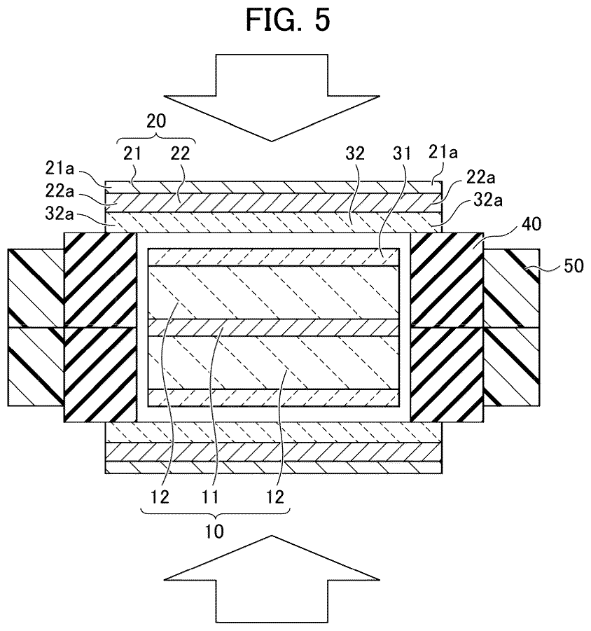

A method of manufacturing the solid-state secondary battery in the first embodiment will be described with reference to FIG. 5. FIG. 5 is a sectional view illustrating one process of the method of manufacturing the solid-state secondary battery according to the first embodiment. First, the first solid electrolyte layer 31 is laminated on each of surfaces of the two positive electrode active material layers 12 of the positive electrode layer 10. Next, the body 40 with a low Young's modulus is placed on the side surfaces of the positive electrode layer 10, and the body 50 with a high Young's modulus is placed on the outer periphery of the body 40 with a low Young's modulus. Next, the second solid electrolyte layer 32 is laminated on the surface of the first solid electrolyte layer 31. The second solid electrolyte layer 32 is placed so that the second solid electrolyte layer projection 32a contacts the body 40 with a low Young's modulus. Next, the negative electrode layer 20 is laminated on the surface of the second solid electrolyte layer 32. Then, the obtained laminate is pressed in a laminating direction of each layer. By pressing, the electrode laminate 1 is generated, the deformed portion 41 is formed in the body 40 with a low Young's modulus, and the body 40 with a low Young's modulus is spread and deformed toward the positive electrode layer 10 side, so that the gap between the body 40 with a low Young's modulus and the positive electrode layer 10 is filled. The electrode laminate 1 is housed in the exterior housing material in a state of being restrained so that a state in which the gap between the body 40 with a low Young's modulus and the positive electrode layer 10 is filled is maintained, which is used as the solid-state secondary battery.

According to the solid-state secondary battery in the first embodiment configured as described above, the body 40 with a low Young's modulus is spread and deformed toward the positive electrode layer 10 side by being pressed by the second solid electrolyte layer projection 32a, and thus a gap between the positive electrode layer 10 and the body 40 with a low Young's modulus can be reduced. The body 40 with a low Young's modulus is a body with a low Young's modulus that is spread and deformed in a direction perpendicular to a pressing direction by being pressed, the body 50 with a high Young's modulus is placed on the outer periphery of the body 40 with a low Young's modulus, and thus the body 40 with a low Young's modulus pressed by the second solid electrolyte layer projection 32a becomes easily spread and deformed toward the positive electrode layer 10 side. This makes it possible for the body 40 with a low Young's modulus to adhere more easily to the positive electrode layer 10, thereby insulating the side surfaces of the positive electrode layer 10 for a longer period of time without generating a gap.

According to the method of manufacturing the solid-state secondary battery of the first embodiment, a laminate in which the solid electrolyte layer is placed between the positive electrode layer and the negative electrode layer is pressed to obtain the electrode laminate 1, a portion of the body 40 with a low Young's modulus is pressed to adhere to the side surfaces of the positive electrode layer 10, and thus it is possible to industrially advantageously manufacture the solid-state secondary battery.

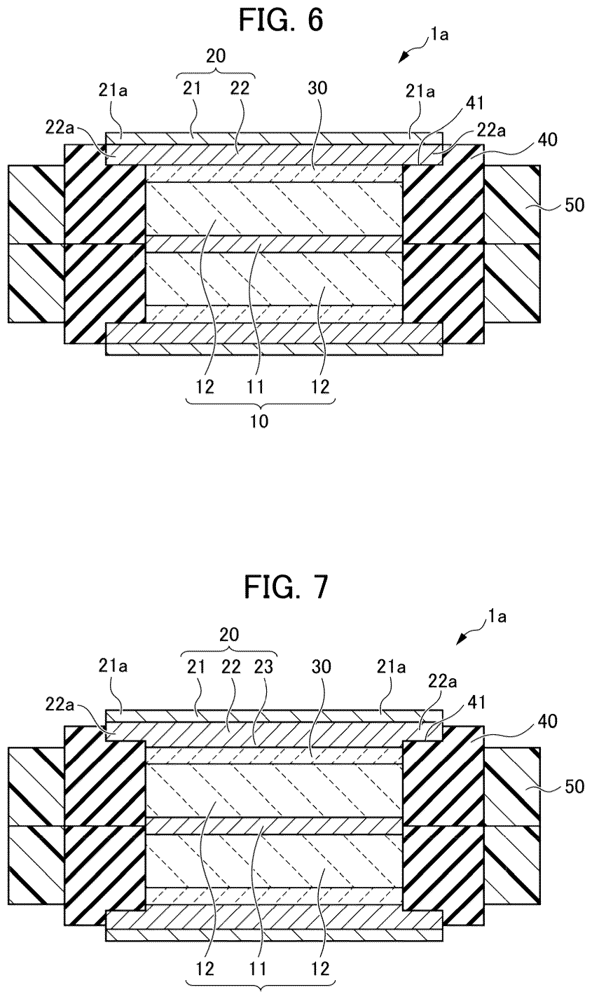

In the electrode laminate 1, the solid electrolyte layer 30 is a laminate including the first solid electrolyte layer 31 and the second solid electrolyte layer 32, but the solid electrolyte layer 30 may be a single layer. A modified example in which the solid electrolyte layer 30 is a single layer will be described with reference to FIGS. 6 and 7.

FIG. 6 is a sectional view illustrating a modified example of the solid-state secondary battery according to the first embodiment of the present invention, and FIG. 7 is a sectional view illustrating the solid-state secondary battery of the modified example in a charged state. An electrode laminate 1a illustrated in FIGS. 6 and 7 is the same as the electrode laminate 1 except that the solid electrolyte layer 30 is a single layer, and thus the same members are designated by the same reference numerals, and duplicate description thereof will be omitted.

As illustrated in FIG. 6, in the electrode laminate 1a, the solid electrolyte layer 30 has the same dimensions as the positive electrode layer 10 in a plan view. The metal layer 22 of the negative electrode layer 20 has a metal layer projection 22a projecting from an edge of the positive electrode layer 10 in a plan view. The metal layer projections 22a are placed on opposite sides of the positive electrode layer 10 to face each other. The negative electrode current collector 21 has the same dimensions as the metal layer 22 in a plan view, and has a negative electrode current collector projection 21a. The body 40 with a low Young's modulus includes a deformed portion 41 deformed by being pressed by the negative electrode current collector projection 21a.

As illustrated in FIG. 7, in the electrode laminate 1a after charging, a lithium deposited layer 23 is generated on a surface of the metal layer 22 of the negative electrode layer 20, resulting in an increase in thickness of the negative electrode layer 20 in a portion facing the positive electrode layer 10. If a constant pressure is applied to the body 40 with a low Young's modulus from the metal layer projection 22a even when the lithium deposited layer 23 is generated, a gap is not generated between the metal layer projection 22a and the body 40 with a low Young's modulus.

According to the solid-state secondary battery in the modified example configured as described above, the body 40 with a low Young's modulus is spread and deformed toward the positive electrode layer 10 side by being pressed by the second solid electrolyte layer projection 32a, and thus a gap between the positive electrode layer 10 and the body 40 with a low Young's modulus can be reduced. In addition, according to the solid-state secondary battery in the modified example, the solid electrolyte layer 30 in the electrode laminate 1a is a single layer, and thus the configuration is simplified.

### Second Embodiment

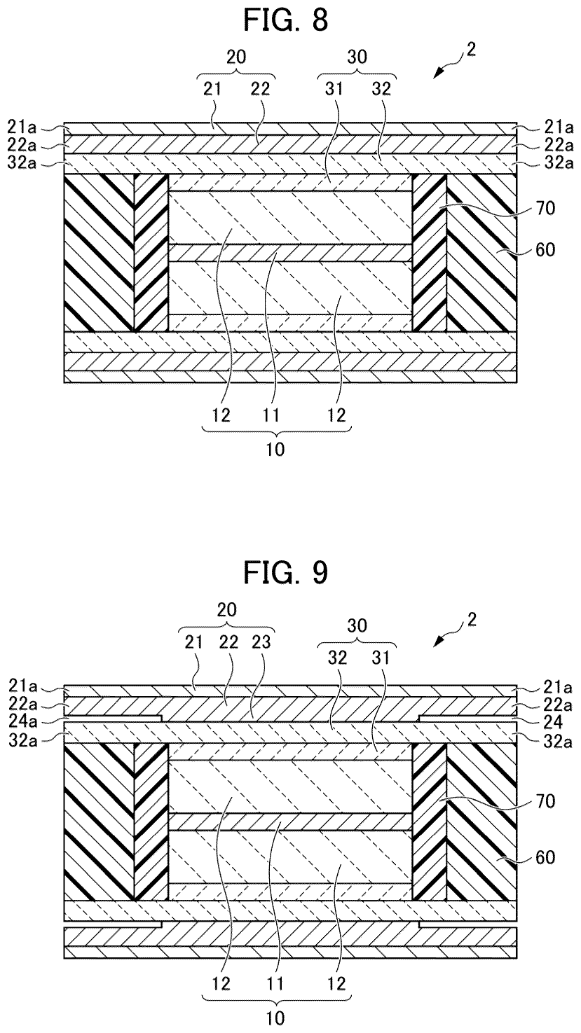

FIG. 8 is a plan view illustrating a solid-state secondary battery according to a second embodiment of the present invention. FIG. 9 is a sectional view illustrating the solid-state secondary battery according to the second embodiment in a charged state. FIGS. 8 and 9 each correspond to the sectional view taken along line III-III of FIG. 1.

As illustrated in FIG. 8, the solid-state secondary battery includes, as an insulating frame, a composite 65 including a porous body 60, and a gelatinous insulating material 70 immersed in the porous body 60. The composite 65 can extrude the gelatinous insulating material 70 in a direction perpendicular to a pressing direction by being pressed. The composite 65 is placed on side surfaces of a positive electrode layer 10 in an electrode laminate 2. A negative electrode current collector projection 21a, a metal layer projection 22a, and a second solid electrolyte layer projection 32a in the electrode laminate 2 extend to an end of the composite 65 opposite to the positive electrode layer 10 side. When the composite 65 is pressed by the second solid electrolyte layer projection 32a in a laminating direction of the electrode laminate 2, the gelatinous insulating material 70 is extruded toward the positive electrode layer 10 side. The extruded gelatinous insulating material 70 is filled in a gap between the composite 65 and the positive electrode layer 10. The electrode laminate 2 is the same as the electrode laminate 1 except for the shapes of the negative electrode current collector projection 21a, the metal layer projection 22a, and the second solid electrolyte layer projection 32a, and thus the same members are designated by the same reference numerals, and duplicate description thereof will be omitted.

The porous body 60 may have any shape and material as long as the gelatinous insulating material 70 can be immersed thereinto and the porous body 60 is deformable in a direction perpendicular to a pressing direction by being pressed so that the immersed gelatinous insulating material 70 can be extruded. The porous body 60 has electron insulating properties. The melting point of the porous body 60 may be a temperature equal to or higher than the melting point of the lithium. The porous body 60 preferably has chemical resistance. As the porous body 60, for example, a rein material having a communication hole can be used.

The gelatinous insulating material 70 has electron insulating properties, and has fluidity, or may have fluidity which allows filling between the composite 65 and the positive electrode layer 10. The melting point of the gelatinous insulating material 70 may be a temperature equal to or higher than the melting point of the lithium. The gelatinous insulating material 70 preferably has chemical resistance. As the material of the gelatinous insulating material 70, a silicone resin, rubber (for example, a binder liquid solution), or the like can be used.

As illustrated in FIG. 9, in the electrode laminate 2 in a charged state, a lithium deposited layer 23 is generated on a surface of the metal layer 22 of the negative electrode layer 20, resulting in an increase in thickness of the negative electrode layer 20 in a portion facing the positive electrode layer 10. This makes it difficult to generate a gap between the gelatinous insulating material 70 and the positive electrode layer 10 if a constant pressure is applied to the composite 65 from the second solid electrolyte layer projection 32a even when a slight gap 24 is formed between the metal layer projection 22a and the second solid electrolyte layer projection 32a.

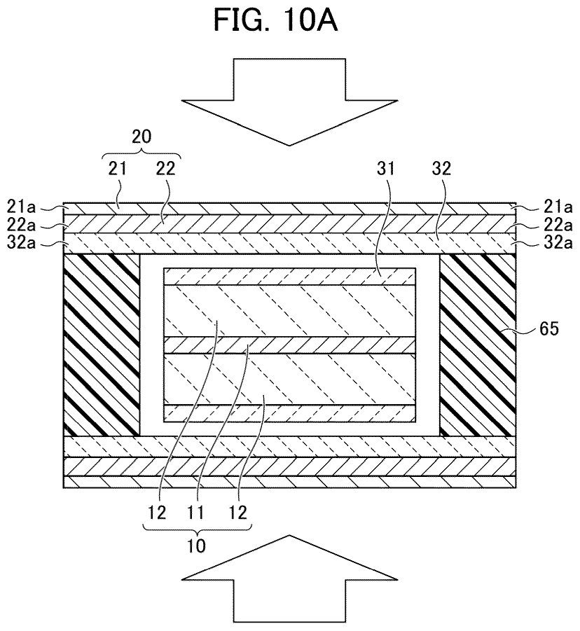

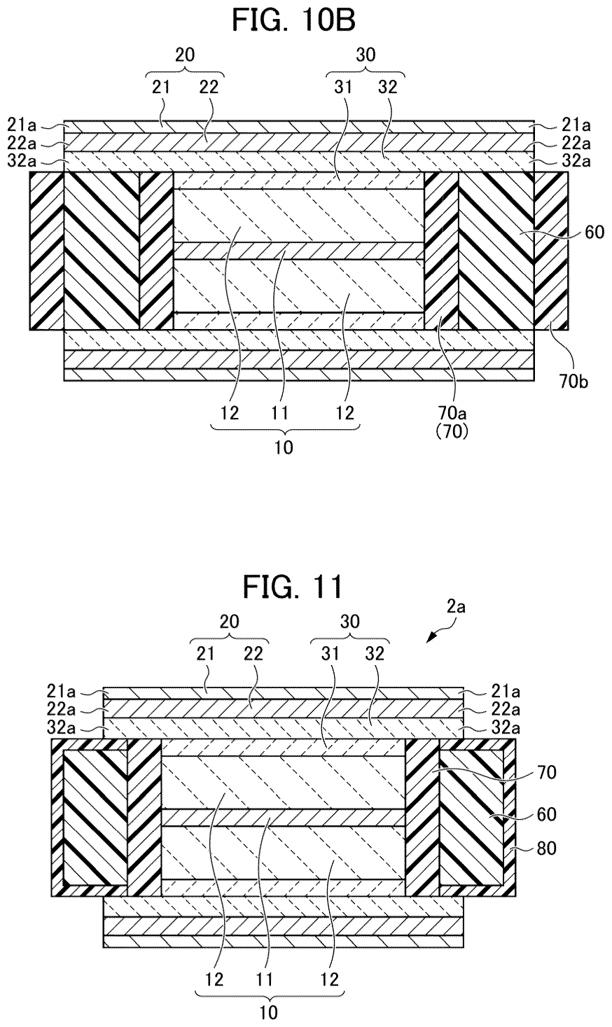

A method of manufacturing the solid-state secondary battery in the second embodiment will be described with reference to FIGS. 10A and 10B. FIGS. 10A and 10B each illustrate one process of the method of manufacturing the solid-state secondary battery according to the second embodiment of the present invention.

First, the first solid electrolyte layer 31 is laminated on each of surfaces of the two positive electrode active material layers 12 of the positive electrode layer 10. Next, the composite 65 in which the gelatinous insulating material 70 is immersed in the porous body 60 is placed on the side surfaces of the positive electrode layer 10. Next, the second solid electrolyte layer 32 is laminated on the surface of the first solid electrolyte layer 31. The second solid electrolyte layer 32 is placed so that the second solid electrolyte layer projection 32a contacts the composite 65. Next, the negative electrode layer 20 is laminated on the surface of the second solid electrolyte layer 32. Then, the obtained laminate is pressed in a laminating direction of each layer, as illustrated in FIG. 10A. As illustrated in FIG. 10B, by pressing, the gelatinous insulating material 70 flows out to the positive electrode layer 10 side of the composite 65, so that the gelatinous insulating material 70 is filled between the composite 65, the metal layer projection 22a and the positive electrode layer 10. Then, a gelatinous insulating material 70b is removed, the gelatinous insulating material 70b having flowed out to an outer peripheral surface of the porous body 60 on an opposite side of the positive electrode layer 10 side. The electrode laminate 2 is housed in the exterior housing material in a state of being restrained so that a state in which a gelatinous insulating material 70a is filled is maintained, which is used as the solid-state secondary battery.

According to the solid-state secondary battery in the second embodiment configured as described above, the gelatinous insulating material 70 forced out from the composite 65 is filled in the side surfaces of the positive electrode layer 10 in the electrode laminate 2, and thus a gap between the positive electrode layer 10 and the composite 65 can be reduced. In addition, using the composite 65 in which the gelatinous insulating material 70 is immersed in the porous body 60 enables the gelatinous insulating material 70 to be filled in the side surfaces of the positive electrode layer 10 only by pressing the composite 65 with the second solid electrolyte layer projection 32a. Furthermore, the gelatinous insulating material 70 is filled between the second solid electrolyte layer projections 32a on opposite sides of the positive electrode layer 10 to face each other, and thus the side surfaces of the positive electrode layer 10 can be insulated more stably.

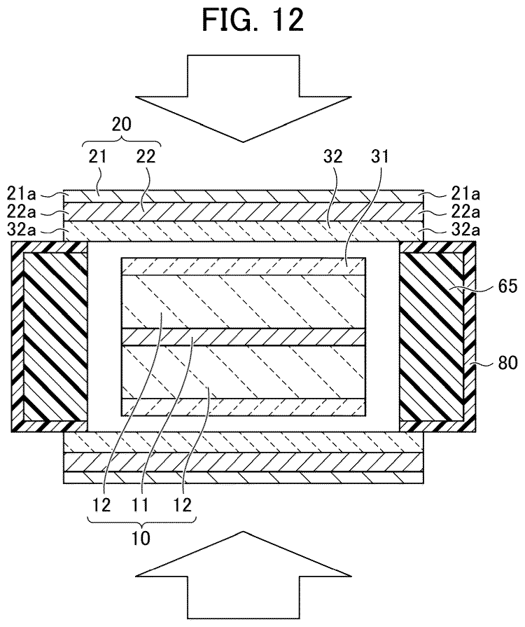

The outer peripheral surface of the composite 65 on an opposite side of the positive electrode layer 10 side in the electrode laminate 2 may be covered by a non-porous member. A modified example in which the non-porous member is provided will be described with reference to FIGS. 11 and 12.

FIG. 11 is a sectional view illustrating a modified example of the solid-state secondary battery according to the second embodiment of the present invention, and FIG. 12 is a sectional view illustrating one process of a method of manufacturing the solid-state secondary battery of the modified example. An electrode laminate 2a is the same as the electrode laminate 2 except that the negative electrode current collector projection 21a, the metal layer projection 22a, and the second solid electrolyte layer projection 32a extend to a portion of the composite 65 on an opposite side of the positive electrode layer 10 side, and thus the same members are designated by the same reference numerals, and duplicate description thereof will be omitted.

As illustrated in FIG. 11, the outer peripheral surface of the composite 65 on an opposite side of the positive electrode layer 10 side in the electrode laminate 1 is covered by a non-porous member 80. The non-porous member 80 has a function of not allowing permeation of the gelatinous insulating material 70. As the material of the non-porous member 80, for example, resin, a ceramic material, or a mixture of resin and a ceramic material can be used. The resin includes rubber and elastomer. Examples of the resin include PET, PTFE, PI, PVdF, and SBR. The resin and the ceramic material may be used alone or two or more thereof may be used in combination.

As illustrated in FIG. 12, covering the composite 65 with the non-porous member 80 makes it possible to prevent the gelatinous insulating material 70 from flowing out from the outer peripheral surface of the porous body 60 on the opposite side of the positive electrode layer 10 side while the laminate is pressed in the laminating direction in the manufacture of the solid-state secondary battery.

Although the embodiments of the present invention have been described above, the present invention is not limited to the embodiments described above.

Although in the present embodiment, the positive electrode layer 10 is provided in which the positive electrode active material layer 12 is laminated on each surface of the positive electrode current collector 11, the shape of the positive electrode layer 10 is not limited thereto. For example, the positive electrode active material layer 12 may be laminated only on one surface of the positive electrode current collector 11. In a case where the positive electrode active material layer 12 is a single layer, the positive electrode current collector 11 of the positive electrode layer 10 may have a projection projecting from an edge of the positive electrode active material layer 12 in a plan view, so that the insulating frame (the body 40 with a low Young's modulus, the composite 65) is placed between the projection of the positive electrode current collector 11 and the projection of at least one of the negative electrode layer 20 and the solid electrolyte layer 30. The insulating frame is pressed by the projection of the positive electrode current collector 11 and the projection of one of the negative electrode layer 20 and the solid electrolyte layer 30 so as to be spread toward the positive electrode layer 10 side, thereby making it possible to insulate the side surfaces of the positive electrode active material layer 12 more stably.

Although in the present embodiments, the electrode laminate 1, 2 is a laminate that includes the positive electrode layer 10, the negative electrode layer 20, and the solid electrolyte layer 30 placed between the positive electrode layer 10 and the negative electrode layer 20, the configuration of the electrode laminate 1, 2 is not limited thereto. For example, an intermediate layer may be provided between the negative electrode layer 20 and the solid electrolyte layer 30. The intermediate layer includes a material having the conductivity for the lithium ions and a material having the electron conductivity, and may be a layer having the electron conductivity and having pores through which lithium ions can pass. As the material having the conductivity for the lithium ions, for example, amorphous carbon particles can be used. As the material having the electron conductivity, for example, metal particles can be used. As the intermediate layer, for example, a layer of metal which generates an alloy with lithium may be used.

Although in the present embodiment, the insulating frame (the body 40 with a low Young's modulus, the composite 65) is pressed by the projection (the second solid electrolyte layer projection 32a, the metal layer projection 22a) projecting from an edge of the positive electrode layer 10 in a plan view, the present invention is not limited thereto. For example, if the insulating frame can be fixed in a state of being adhered to the positive electrode layer 10 by being pressed in the manufacture of the electrode laminate, it is not necessary to press the insulating frame with the projection.

Although in the present embodiment, the negative electrode layer 20 includes the metal layer 22, the metal layer 22 may be omitted so that the lithium can be deposited on the surface of the negative electrode current collector 21. Instead of the metal layer 22, a layer may be used which includes a negative electrode active material capable of absorbing and releasing lithium ions. Examples of the negative electrode active material include lithium transition metal oxides such as lithium titanate, transition metal oxides such as TiO₂, Nb₂O₃, and WOn, Si, Sio, metal sulfides, metal nitrides, and carbon materials such as artificial graphite, natural graphite, graphite, soft carbon and hard carbon. In terms of enhancing the conductivity for the lithium ions, the negative electrode active material layer may optionally include a solid electrolyte. The negative electrode active material layer may optionally include a conductive aid to enhance the conductivity. Furthermore, in terms of developing the flexibility, the negative electrode active material layer may optionally include a binder. As the solid electrolyte, the conductive aid and the binder, a solid electrolyte, a conductive aid, and a binder which are used in a general solid-state secondary battery can be used.

### EXPLANATION OF REFERENCE NUMERALS

1 electrode laminate
10 positive electrode layer
11 positive electrode current collector
12 positive electrode active material layer
15 positive electrode current collecting tab
20 negative electrode layer
21 negative electrode current collector
21a negative electrode current collector projection
22 metal layer
22a metal layer projection
23 lithium deposited layer
24 gap
25 negative electrode current collecting tab
30 solid electrolyte layer
31 first solid electrolyte layer
32 second solid electrolyte layer
32a second solid electrolyte layer projection
40 body with low Young's modulus
41 deformed portion
50 body with high Young's modulus
60 porous body
65 composite
70, 70a, 70b gelatinous insulating material
80 non-porous member

What is claimed is:

1. A solid-state secondary battery comprising:
an electrode laminate that includes a positive electrode layer, a negative electrode layer, and a solid electrolyte layer laminated between the positive electrode layer and the negative electrode layer; and
an insulating frame placed on side surfaces of the positive electrode layer with a gap between the positive electrode layer and the insulating frame,
wherein at least a portion of the insulating frame is pressed in a laminating direction of the electrode laminate and is spread toward a side of the positive electrode layer.

2. The solid-state secondary battery according to claim 1, wherein
the insulating frame includes a body with a low Young's modulus and a body with a high Young's modulus placed on an outer periphery of the body with a low Young's modulus,
the body with a low Young's modulus is spreadable and deformable in a direction perpendicular to a pressing direction by being pressed,
the body with a high Young's modulus has a Young's modulus higher than a Young's modulus of the body with a low Young's modulus, and
at least a portion of the body with a low Young's modulus of the insulating frame is spread and deformed toward the side of the positive electrode layer by being pressed in the laminating direction of the electrode laminate.

3. The solid-state secondary battery according to claim 1, wherein
the insulating frame includes a composite that includes a porous body, and a gelatinous insulating material immersed in the porous body,
the composite can extrude the gelatinous insulating material in a direction perpendicular to a pressing direction by being pressed, and
at least a portion of the composite of the insulating frame is pressed in the laminating direction of the electrode laminate, so that the gelatinous insulating material is extruded toward the side of the positive electrode layer.

4. The solid-state secondary battery according to claim 3, wherein
the insulating frame further includes a non-porous member that covers an outer peripheral surface of the composite on an opposite side of the side of the positive electrode layer.

5. The solid-state secondary battery according to claim 1, wherein
at least one of the solid electrolyte layer and the negative electrode layer has a projection projecting from an edge of the positive electrode layer in a plan view, and
at least a portion of the insulating frame is pressed via the projection.

6. The solid-state secondary battery according to claim 1, wherein
the positive electrode layer includes a positive electrode current collector, and a positive electrode active material layer laminated on one surface or both surfaces of the positive electrode current collector, and
the negative electrode layer and the solid electrolyte layer are placed on opposite sides of the positive electrode layer to face each other.

7. A method of manufacturing a solid-state secondary battery comprising: an electrode laminate that includes a positive electrode layer, a negative electrode layer, and a solid electrolyte layer laminated between the positive electrode layer and the negative electrode layer; and an insulating frame placed on side surfaces of the positive electrode layer, the method comprising;
placing the solid electrolyte layer between the positive electrode layer and the negative electrode layer, pressing the insulating frame in a state of being placed on side surfaces of the positive electrode layer with a gap between the insulating frame and the positive electrode layer to obtain the electrode laminate, and pressing and spreading at least a portion of the insulating frame so that at least a portion of the gap is filled.
